(19) United States
(12) Patent Application Publication
(10) Pub. No.: US 2021/0178736 A1
(43) Pub. Date: Jun. 17, 2021

(54) LABEL OR LABEL FACESTOCK WITH POST-CONSUMER RECYCLE CONTENT

(71) Applicant: Multi-Color Corporation, Batavia, OH (US)

(72) Inventor: James R. DeFife, Liberty Township, OH (US)

(21) Appl. No.: 17/118,969

(22) Filed: Dec. 11, 2020

Related U.S. Application Data
(60) Provisional application No. 62/947,648, filed on Dec. 13, 2019.

(51) Int. Cl. B32B 27/08; B32B 27/36; B32B 27/32; B32B 7/12; G09F 3/02; G09F 3/10

(52) U.S. Cl. CPC B32B 27/08; B32B 27/36; B32B 27/32; B32B 7/12; G09F 3/02; G09F 3/10; G09F 2003/0241; B32B 2272/00; B32B 2519/00; B32B 2307/75; B32B 2307/518; G09F 2003/0257; B32B 2307/72

(57) ABSTRACT

A label and a facestock for a label, wherein the facestock includes a first facestock material and a second facestock material. The first facestock material includes post-consumer recycle content, and the second facestock material includes desirable characteristics, e.g., a density of less than 1 g/cm³.

### CROSS-REFERENCE TO RELATED APPLICATION

This application claims the benefit of the filing date of U.S. Patent Application Ser. No. 62/947,648, filed on Dec. 13, 2019, the disclosure of which is incorporated by reference herein in its entirety.

### FIELD OF THE INVENTION

The present invention relates to labels and facestock for labels, and more specifically to labels that include post-consumer recycle content and facestock for labels, wherein the facestock includes post-consumer recycle content.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Sustainable products, such as articles made from sustainable materials, have become popular and in demand in many industries. Thus, many industries seek to provide customers and end-users with products that include post-consumer recycle content (i.e., include materials recycled from the post-consumer waste stream). The advantage for industry is that the waste-stream is used as an input stream to the production process for new products, and material that may traditionally end up in a landfill is reused (consistent with the philosophy of a circular economy). As used herein, “post-consumer materials” are materials generated by households or by commercial, industrial, and institutional facilities in their role as end users of a product that can no longer be used for its intended purpose. This includes returns of material from the distribution chain. As used herein, “post-consumer materials” excludes pre-consumer material (e.g. production scrap).

In many cases, end users (e.g., customers) create a demand for such sustainable materials or sustainable products. For example, in the packaging and label industry, a label facestock including post-consumer recycle content (i.e., the facestock includes recycled materials) is often requested. However, many materials that are typically used for labels or label facestock prevent or hinder the ability to provide a label or facestock that includes such post-consumer recycle content. For example, biaxially-oriented polypropylene (“BOPP”) is used quite extensively as a film label facestock. However, due to technical issues in producing such a product and lack of a source of post-consumer resin as a raw material, BOPP having post-consumer recycle content is not currently available in the market.

On the other hand, PET films, while not extensively used as facestocks, are readily available with post-consumer recycle content. In certain of these PET films, the post-consumer recycle content can range from 30-90%. This is because recycled PET resin is available as a feed source for PET film makers, and a post-consumer recycle PET film is of high quality. However, PET is expensive and has some negative performance features as a label facestock. One such negative performance feature is that, because such PET has a density greater than water (water having a density of 1 g/cm³), a PET film facestock cannot be used on a PET bottle when the bottle is intended for recycling. If the PET label comes off the bottle, it sinks and cannot be cleanly separated from the PET bottle. And so, BOPP facestocks, with densities below 1 g/cm³, are preferred since the label floats when it comes off the bottle. Therefore, there is a lack of desired facestock films when a material like BOPP is preferred but post-consumer recycle content is required or requested.

In view of the drawbacks described above, a label facestock including a material like BOPP, but also including post-consumer recycle content, is needed.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

As described above, current label facestocks (and thus labels including such facestocks) are often prepared from materials that prevent or hinder the ability to provide a label or facestock that includes post-consumer recycle content. And so, such facestocks and labels are often not available when the marketplace demands a label that includes recycled materials, but also has good performance characteristics.

And so, various aspects of the present invention overcome these and other drawbacks by providing a label and/or facestock for a label that includes post-consumer recycle content, and has good performance characteristics. To that end, aspects of the current invention combine (1) a film including post-consumer recycle content with (2) a film having desirable performance characteristics to provide a facestock (or label) having both performance and recycled characteristics.

In one embodiment, a PET film with post-consumer recycle content may be combined with a BOPP film to provide a label facestock that has a post-consumer recycle content that is desired, while also exhibiting desired performance characteristics. For example the presence of the PET film in such an embodiment, may provide a post-consumer recycle content of the overall facestock of at least 30%. Furthermore, such a combination of films can yield a facestock with post-consumer recycle content that will float in the recycle stream if used on a PET bottle. Alternatively, this structure could also be used on a glass container, for example, if the desire is simply to have a BOPP based film with post-consumer recycle (“PCR”) content which has good economics. The facestock may be used for various types of labels—one example of which is a pressure sensitive label.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a schematic of one exemplary embodiment of a label in accordance with the principles of the present invention.

FIG. 2 is a schematic of another exemplary embodiment of a label in accordance with the principles of the present invention.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, current label facestocks (and thus labels including such facestocks) are often prepared from materials that prevent or hinder the ability to provide a label or facestock that includes post-consumer recycle content. And so, such facestocks and labels are often not available when the marketplace demands a label that includes recycled materials, but also has good performance characteristics.

And so, various aspects of the present invention overcome these and other drawbacks by providing a label and/or facestock for a label that includes post-consumer recycle content, and has good performance characteristics. To that end, aspects of the current invention combine (1) a film including post-consumer recycle content with (2) a film having desirable performance characteristics to provide a facestock (or label) having both performance and recycled characteristics.

In one embodiment, a PET film with post-consumer recycle content may be combined with a BOPP film to provide a label facestock that has a post-consumer recycle content that is desired, while also exhibiting desired performance characteristics. For example the presence of the PET film in such an embodiment, may provide a post-consumer recycle content of the overall facestock of at least 30%. Furthermore, such a combination of films can yield a facestock with post-consumer recycle content that will float in the recycle stream if used on a PET bottle. Alternatively, this structure could also be used on a glass container, for example, if the desire is simply to have a BOPP based film with PCR content which has good economics. The facestock may be used for various types of labels—one example of which is a pressure sensitive label.

The embodiments of facestock, and labels including such facestock, described herein may be used on many different types of containers. Two examples of such containers are glass containers and PET containers. An overarching aspect of the present invention includes a plurality of layers, which may include a first facestock material and a second facestock material. In various embodiments, the first and second facestock materials may be selected to combine various characteristics of those materials to provide a total facestock that exhibits both a sufficient or desired amount of post-consumer recycle content, and desired performance characteristics. For example, the first facestock material may be BOPP. And, for example, the second facestock material may be PET. When a facestock (or label having facestock) is constructed having such a first material (BOPP) and a second material (PET)—the combined constructed facestock may exhibit good performance characteristics due to the presence of the BOPP as a portion of the facestock, and may be able to be placed in a post-consumer recycle stream due to the presence of the PET.

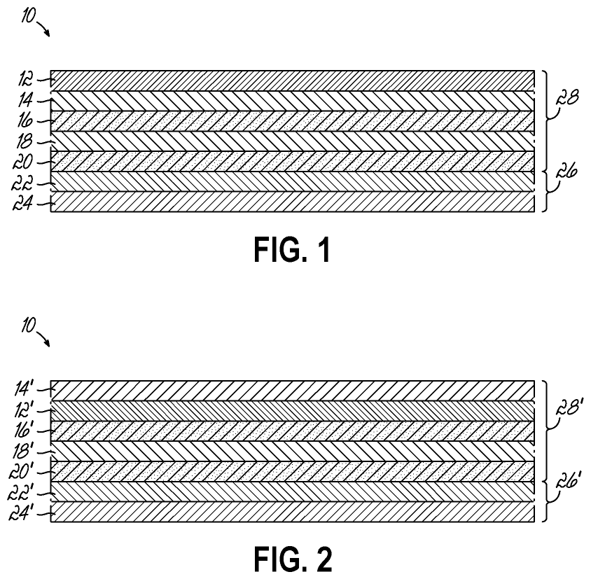

The facestock (or label including facestock) described herein may also include additional layers. Referring now to FIG. 1, in one exemplary embodiment, the layers of a facestock or label 10 may include: (1) a printed layer 12; (2) a first facestock material 14; (3) a first adhesive 16; (3) a second facestock material 18; (4) a second adhesive 20; (5) a release layer 22; and (6) a liner 24. At least one of the first and second facestock materials may include post-consumer recycle content. The first four of these listed layers may provide a transfer portion 28 and the last two of these listed layers may provide a support portion 26. In use, when the facestock, or label made from such facestock, is applied to an article, the transfer portion 28 is applied to the article while the support portion 26 is separated from the transfer portion 26 (the release layer 22 facilitating separation of the transfer portion 28 from the support portion 26).

Thus, in one example, the first facestock material may be BOPP and the second facestock material may be PET having post-consumer recycle content. The first adhesive (which is positioned between the first and second facestock materials) may be a laminating adhesive to laminate the first and second facestock materials to one another. Inks and coatings, for example, may be applied to the surface of the first facestock material opposite the laminating adhesive to provide a printed layer. These inks, coatings, etc. may be used to form the text, graphics, indicia, etc. of the label that will be visible when the label is applied to a container. And so, the first facestock material (to which these inks, coatings, etc. may be applied) may be a material having good performance characteristics for the printed layer and the label. The second facestock material, then, may be used to provide (or increase) the post-consumer recycle content of the overall facestock or overall label.

The second adhesive layer (positioned on the surface of the second facestock material opposite the laminating adhesive) is an adhesive that will be used ultimately to apply the label to an article, such as a container. Thus, this second adhesive may be selected based on the material of the article to which the label is to be applied. The remaining liner and release layer provide a support for the other layers (the label layers) prior to their application to a container. The liner provides the bulk of support, while the release layer is of a material that allows the second adhesive to separate therefrom to be applied to a container. As such, the liner and release layer may be considered a support portion 26; and the printed layer, first facestock material, first adhesive, second facestock material, and second adhesive may be considered a transfer portion 28 (though the possibility that some release material may also transfer should be noted).

In one particular embodiment, the plurality of the layers may include [from the top of the label (i.e., the outside surface) down to the base liner]: (1) a printed layer (e.g., inks and coatings); (2) a 30 to 66 micron white cavitated BOPP as the first facestock material; (3) a laminating adhesive (solvent or solventless) as the first adhesive; (4) a 15 micron to 30 micron 30-90% PCR PET (suitable such film is commercially available from Mitsubishi and FlexFilm) as the second facestock material; (5) a 10 gsm (grams per square meter) acrylic adhesive as the second adhesive; (6) a silicone release layer; and (7) a 23 micron 30% PCR liner (such as is commercially available from Mitsubishi or Dupont). As described above, the second adhesive may be chosen based on the particular container to which the label is to be applied. And so, for example, the acrylic adhesive of this particular embodiment may be an A210 adhesive if the container is glass, and a C742 adhesve if the container is PET.

This particular embodiment yields a range of PCR content from about 16% to about 47% PCR total construction for the face stock—as shown in Table 1 (below).

TABLE 1

| | PCR content | Basis | Basis | Basis | Basis |
|---|---|---|---|---|---|
| | of PET w/ | Wt | Wt | Wt | Wt |
| | PCR | (g/m²) | (g/m²) | (g/m²) | (g/m²) |
| 23 micron | | 32 | 32 | 32 | 32 |
| PET w/PCR | | | | | |
| | 30% | 9.6 | | | |
| | 50% | | 16 | | |
| | 70% | | | 22.4 | |
| | 90% | | | | 28.8 |
| 38 micron | | 29 | 29 | 29 | 29 |
| cavitated | | | | | |
| BOPP | | | | | |
| Total Basis | | 61 | 61 | 61 | 61 |
| Weight | | | | | |
| % PCR | | 16% | 26% | 37% | 47% |
| content of | | | | | |
| laminate | | | | | |

A more specific version, based on the embodiment described above, may include: (1) a printed layer (inks and coatings); (2) a 38 micron white cavitated BOPP as the first facestock material; (3) a laminating adhesive (solvent or solventless) as the first adhesive; (4) a 23 micron 70% PCR PET (commercially available from Mitsubishi or FlexFilm) as the second facestock material; (5) a 10 gsm acrylic adhesive as the second adhesive; (6) a silicone release layer; and (7) a 23 micron 30% PCR liner (commercially available from Mitsubishi or Dupont). This combination yields 37% PCR total construction for the facestock.

In another example, and referring now to FIG. 2, the order of the printed materials and a facestock material of a label 10′ may be reversed, such that the layers include (1) a first facestock material 14′; (2) a printed layer 12′; (3) a first adhesive 16′; (3) a second facestock material 18′; (4) a second adhesive 20′; (5) a release layer 22′; and (6) a liner 24′. At least one of the first and second facestock materials may include post-consumer recycle content. The first four of these listed layers may provide a transfer portion 28′ and the last two of these listed layers may provide a support portion 26′.

In a particular embodiment of this example, the layers may include [from the top of the label (i.e., the outside surface) down to the base liner]: (1) a 15 micron to 30 micron 30-90% PCR PET (commercially available from Mitsubishi or FlexFilm) as a first facestock material; (2) a printed layer (inks and coatings); (3) a laminating adhesive (solvent or solventless) as a first adhesive; (4) a 30 to 66 micron White cavitated BOPP as a second facestock material; (5) 10 gsm acrylic adhesive as a second adhesive; (6) a silicone release layer; and (7) a 23 micron 30% PCR liner (commercially available from Mitsubishi or Dupont). As described above, the second adhesive may be chosen based on the particular container to which the label is to be applied. And so, for example, the acrylic adhesive of this particular embodiment may be A210 if the container is glass, and C742 if the container is PET.

This embodiment yields a range of PCR content from about 18% to about 53% PCR total construction for the face stock—as shown in Table 2 (below).

TABLE 2

| | PCR content | Basis | Basis | Basis | Basis |
|---|---|---|---|---|---|
| | of PET w/ | Wt | Wt | Wt | Wt |
| | PCR | (g/m²) | (g/m²) | (g/m²) | (g/m²) |
| 30 micron | | 42 | 42 | 42 | 42 |
| PET w/PCR | | | | | |
| | 30% | 12.6 | | | |
| | 50% | | 21 | | |
| | 70% | | | 29.4 | |
| | 90% | | | | 37.8 |
| 38 micron | | 29 | 29 | 29 | 29 |
| cavitated | | | | | |
| BOPP | | | | | |
| Total Basis | | 71 | 71 | 71 | 71 |
| Weight | | | | | |
| % PCR | | 18% | 30% | 41% | 53% |
| content of | | | | | |
| laminate | | | | | |

As a result of the various aspects of the present invention, as described above, a label or label facestock, as described herein, can provide a film label facestock that has a high percentage of post-consumer recycle content and a density less than 1 g/cm³ for use as a recyclable label with olefin content on PET containers. It also can provide a film label facestock with a high percentage of post-consumer recycle content and good opacity for beverage or personal care applications where a white label is required. And it can also provide a lower cost alternative to white PET with 30% post-consumer recycle content.

The embodiments of the present invention recited herein are intended to be merely exemplary and those skilled in the art will be able to make numerous variations and modifications to it without departing from the spirit of the present invention. Notwithstanding the above, certain variations and modifications, while producing less than optimal results, may still produce satisfactory results. All such variations and modifications are intended to be within the scope of the present invention as defined by the claims appended hereto.

What is claimed is:

1. A facestock for a label, the facestock comprising:
a first facestock material and a second facestock material;
wherein the first facestock material includes post-consumer recycle content; and
wherein the second facestock material has a density of less than 1 g/cm³.

2. The facestock of claim 1, wherein the first facestock material includes PET.

3. The facestock of claim 1, wherein the second facestock material includes BOPP.

4. The facestock of claim 1, wherein the post-consumer recycle content of the first facestock material is 30%-90%.

5. The facestock of claim 1, further comprising a post-consumer recycle content of at least 16%.

6. The facestock of claim 5, further comprising a post-consumer recycle content in the range of 16%-47%.

7. The facestock of claim 5, further comprising a post-consumer recycle content in the range of 18%-53%.

8. The facestock of claim 1, further comprising a first adhesive, the first adhesive being positioned between said first facestock material and said second facestock material.

9. The facestock of claim 8, further comprising a second adhesive, the second adhesive being positioned such that the second facestock material is between the first adhesive and the second adhesive.

10. The facestock of claim 9, further comprising a release layer, the release layer being positioned such that the second adhesive is between the second facestock material and the release layer.

11. The facestock of claim 10, further comprising a liner, the liner being positioned such that the release layer is between the second adhesive and the liner.

12. The facestock of claim 8, further comprising a printable layer, the printable layer being positioned such that the first facestock material is between the printable layer and the first adhesive.

13. The facestock of claim 8, further comprising a printable layer, the printable layer being positioned such that the printable layer is between the first facestock material and the first adhesive.

14. A label comprising:
a facestock comprising a first facestock material and a second facestock material;
wherein the first facestock material includes post-consumer recycle content; and
wherein the second facestock material has a density of less than 1 g/cm³.

15. The label of claim 14, wherein the first facestock material includes PET.

16. The label of claim 14, wherein the second facestock material includes BOPP.

17. The label of claim 14, wherein the post-consumer recycle content of the first facestock material is 30%-90%.

18. The label of claim 14, wherein the facestock further comprises a post-consumer recycle content of at least 16%.

19. The label of claim 18, wherein the facestock further comprises a post-consumer recycle content in the range of 16%-47%.

20. The label of claim 18, wherein the facestock further comprises a post-consumer recycle content in the range of 18%-53%.

21. The label of claim 14, wherein the label has a density of less than 1 g/cm3.

22. The label of claim 14, further comprising a first adhesive, the first adhesive being positioned between said first facestock material and said second facestock material.

23. The label of claim 22, further comprising a second adhesive, the second adhesive being positioned such that the second facestock material is between the first adhesive and the second adhesive.

24. The label of claim 23, further comprising a release layer, the release layer being positioned such that the second adhesive is between the second facestock material and the release layer.

25. The label of claim 24, further comprising a liner, the liner being positioned such that the release layer is between the second adhesive and the liner.

26. The label of claim 22, further comprising a printable layer, the printable layer being positioned such that the first facestock material is between the printable layer and the first adhesive.

27. The label of claim 22, further comprising a printable layer, the printable layer being positioned such that the printable layer is between the first facestock material and the first adhesive.

28. The label of claim 23, wherein the second adhesive is a pressure sensitive adhesive.

29. A facestock for a label, the facestock comprising:
first facestock material and a second facestock material, wherein the first facestock material comprises PET and the second facestock material comprises BOPP.

30. The facestock of claim 29, wherein the PET includes post-consumer recycle content, and wherein the post-consumer recycle content of the PET is 30%-90%.

31. The facestock of claim 30, wherein the facestock further comprises a post-consumer recycle content of at least 16%.

32. The facestock of claim 31, wherein the facestock further comprises a post-consumer recycle content in the range of 16%-47%.

33. The facestock of claim 31, wherein the facestock further comprises a post-consumer recycle content in the range of 18%-53%.

34. The facestock of claim 14, wherein the BOPP has a density of less than 1 g/cm³.
